(19) United States
(12) Patent Application Publication
(10) Pub. No.: US 2009/0143963 A1
(43) Pub. Date: Jun. 4, 2009

(54) Diagnostic of hydraulically switchable engine mechanisms

(76) Inventor: Nick J. Hendriksma, Grand Rapids, MI (US)

Correspondence Address: DELPHI TECHNOLOGIES, INC., M/C 480-410-202, PO BOX 5052, TROY, MI, 48007, US

(21) Appl. No.: 11/998,608

(22) Filed: Nov. 30, 2007

(51) Int. Cl. G01M 15/04

(52) U.S. Cl. 701/114

(57) ABSTRACT

A method for detecting failure modes of latching mechanisms in a hydraulically switchable variable valve activation system of an internal combustion engine includes the steps of: integrating a pressure sensor in an engine control system including a plurality of switchable mechanisms connected to a common hydraulic gallery, an oil control valve downstream of the oil gallery, and en engine controller activating the oil control valve and the pressure sensor; measuring fluid pressure of the gallery with the pressure sensor; and determining if a failure mode of latching mechanisms occurred by evaluating the measured fluid pressure. Sudden flow changes that produce high frequency fluid pressure oscillations in the oil gallery are detected with the pressure sensor and evaluated by an engine controller to detect lock pin failure modes, such as lock pin ejections and operation of two-step RFF in a low lift mode at elevated engine speeds.

### TECHNICAL FIELD

The present invention relates to variable valve activation systems for internal combustion engines; more particularly, to roller finger follower type rocker arm assemblies capable of changing between high and low or no valve lifts; and most particularly, to a method for detecting lock pin failure modes by monitoring the hydraulic pressure in the hydraulic gallery.

### BACKGROUND OF THE INVENTION

Variable valve activation (VVA) mechanisms for internal combustion engines are well known. It is known to be desirable to lower the lift, or even to provide no lift at all, of one or more valves of a multiple-cylinder engine, during periods of light engine load. Such deactivation or cam profile switching can substantially improve fuel efficiency.

Various approaches are known in the prior art for changing the lift of valves in a running engine. One known approach is to provide a latching mechanism in the roller finger follower (RFF) component of the valve train. The latching mechanism locks and unlocks an inner arm to and from the outer arm to switch between high lift and low lift or no lift. For example, the cam follower mechanism may be latchable by a hydraulically actuated lock pin whose motion typically is governed in a latching direction by application of pressurized engine oil received from the HLA and in an unlatching direction by a return spring. The lock pin is disposed as a piston in a smooth bore of the outer body and is retained therein by a plug pressed into the end of the bore. The typically cylindrical plug may serve to seal the smooth bore, thus forming a hydraulic chamber between itself and an end of the lock pin. Valve train switching devices that utilize hydraulically actuated lock pins to implement a mode change are well known.

For example, a two-step rocker arm assembly changes between a high lift and low lift mode of operation depending on the pressure level in the switching gallery. A typical two-step roller finger follower (RFF) allows the engine valves to be operated with two different cam profiles, one when the lock pin is retracted and disengages (unlocks) the inner arm from the outer arm (low lift mode) and the other when the lock pin is expanded and engages (locks) the inner arm with the outer arm (high lift mode). When the HLA oil pressure is low, the return spring moves the lock pin to a retracted position and the lock pin is disengaged from the inner arm or other valve actuator. When HLA oil pressure is increased, the hydraulic force of the oil pressure in the hydraulic chamber overcomes the spring force and the lock pin moves to an extended position engaging the inner arm or other valve actuator with the outer arm or follower body.

However, hydraulic actuation of lock pins suffers from several shortcomings. One known issue with hydraulic actuation of lock pins arises from variation in the time period between the moments when the controller commands a switch and when the lock mechanism actually changes state. The variation can produce an undesirable behavior known as lock pin ejections because the actual motion of the lock pin cannot be controlled precisely with respect to the beginning of a lift event for a particular cylinder. If the lock pin is only partially engaged at the start of the lift event, the pin can be ejected back to the retracted position at some point during the lift event. In other words, the lock mechanism changes state during the valve lift event rather than on the base circle period as desired. This problem is aggravated by elevated engine speeds, where a shorter time is available for lock pin engagement, and/or for systems having an insufficient number of independent control valves. The ejections can produce undesired wear from increased contact stress when the pin engagement is minimal and may produce audible noise. While certain engine design variables may be optimized to minimize the percentage of switches in which a lock pin ejection takes place, it is currently not possible to eliminate lock pin ejections completely without adding complicated and expensive timing mechanisms.

Another known issue with hydraulic actuation of lock pins arises when one or more of the two-step rocker arms fail to switch from low lift mode to high lift mode and the two-step rocker arm assembly remains in low lift mode at elevated engine speeds when operation in high lift mode is desired. Running an engine with a two-step rocker arm stuck in low lift mode could lead to hardware failure because the system is typically not designed to operate at high speed in the low lift mode.

While oil pressure characteristics have been used in the prior art for diagnostic purposes, as described, for example, in U.S. Patent Application Publication No. 2005/0005882, U.S. Pat. No. 7,077,082, U.S. Pat. No. 7,246583, and U.S. Pat. No. 7,103,468, it is currently not possible to detect lock pin ejection and operation of a two-step rocker arm assembly in low lift mode at elevated engine speeds.

What is needed in the art is a method for detecting lock pin failure modes in a hydraulically switchable engine mechanism.

It is a principal object of the present invention to provide a method for detecting lock pin failure modes, such as lock pin ejections as well as operation of two-step rocker arm assemblies in low lift mode at elevated engine speeds.

It is a still further object of the invention to provide a method for monitoring the hydraulic pressure in a hydraulic gallery.

### SUMMARY OF THE INVENTION

Briefly described, a method for detecting lock pin failure modes includes the step of monitoring the pressure in a common HLA supply/switching oil gallery. An oil pressure transducer or pressure sensor positioned between the switchable mechanisms, such as two-step roller finger followers (RFF), and an engine controller is utilized to monitor the oil pressure in the common HLA supply/switching oil gallery. Sudden flow changes that produce high frequency fluid pressure oscillations in the common oil gallery are detected with the pressure sensor and evaluated by an engine controller to detect lock pin failure modes, such as lock pin ejections and operation of two-step RFF in a low lift mode at elevated engine speeds where typically operation in high lift mode is needed.

When a lock pin ejection occurs, the interface between the socket of the outer arm of the two-step roller finger follower and the HLA ball is unloaded and oil pressure acts to separate the two components. As the components separate, oil leakage increases significantly. When the lock pin ejection ends, the outer arm and the HLA are rapidly re-connected and the leakage is abruptly halted. The sudden flow change produces high frequency pressure oscillations in the common oil gallery. Similar oil gallery pressure oscillations are produced when a two-step roller finger follower is operated in low lift mode at elevated engine speeds.

The engine controller may be programmed to monitor and register oil gallery pressure during a specified time interval following a switch command or during operation of the engine at elevated engine speeds. Various methods may be used to post-process the registered oil pressure data and to determine if a lock pin failure mode has occurred. For example, a relatively simple difference equation based on the pressure difference at consecutive data samples or a fast Fourier transform (FFT) method may be utilized to detect high frequency oil pressure fluctuations.

The detection of lock pin failure modes, such as lock pin ejection and operation of the switchable mechanism in low lift mode at elevated engine speeds, may be used in a number of ways. First, the engine controller may adjust the timing of the switch command so as to minimize the number of lock pin ejections. Second, if too many lock pin ejection within a preset time period are detected, the engine controller may indicate a problem, such as by setting diagnostic codes. Third, the number of lock pin ejections for each cylinder may be monitored and the obtained data be used to adjust switch timing in order to distribute lock pin ejections equally across all cylinders, as described, for example, in co-pending U.S. Patent Application Publication No. 2007/0256652. Finally, if it is determined one or more of the two-step arms have not switched to high mode during operation at elevated engine speeds, the controller can set a diagnostic code and protect the hardware by adjusting engine parameters to limit the engine speeds until repairs are made.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a cutaway side elevational view of a prior art two-step roller finger follower;

FIG. 2 is a schematic block diagram of an engine control system in accordance with the present invention;

FIG. 3 is a graph of valve lift and oil pressure as a function of rotation angle in accordance with a first embodiment of the invention;

FIG. 4 is a graph of oil pressure as a function of rotation angle after application of a forward difference equation in accordance with the first embodiment of the invention;

FIG. 5 is a graph of amplitude as a function of harmonic numbers after application of a fast Fourier transform method, in accordance with the first embodiment of the invention;

FIG. 6a is a graph of oil gallery pressure as a function of time at an engine speed of 5200 rpm for normal operation of a two-step roller finger follower in high lift mode, in accordance with a second embodiment of the invention;

FIG. 6b is a graph of oil gallery pressure as a function of time at an engine speed of 5200 rpm for lock pin failure mode, in accordance with the second embodiment of the invention;

FIG. 7a is a graph of oil gallery pressure as a function of time at an engine speed of 5500 rpm for normal operation of a two-step roller finger follower in high lift mode, in accordance with the second embodiment of the invention; FIG. 7b is a graph of oil gallery pressure as a function of time at an engine speed of 5500 rpm for lock pin failure mode, in accordance with the second embodiment of the invention;

FIG. 8 is a graph of standard deviation of oil gallery pressure as a function of engine speed, in accordance with the second embodiment of the invention.

Corresponding reference characters indicate corresponding parts throughout the several views. The exemplification set out herein illustrates preferred embodiments of the invention, in one form, and such exemplification is not to be construed as limiting the scope of the invention in any manner.

### DESCRIPTION OF THE PREFERRED EMBODIMENTS

The advantages and benefits afforded to a two-step roller finger follower (RFF) in accordance with the invention may be better appreciated by first considering a prior art two-step roller finger follower. Such a two-step RFF is suitable for use in a variable valve activation system of an internal combustion engine.

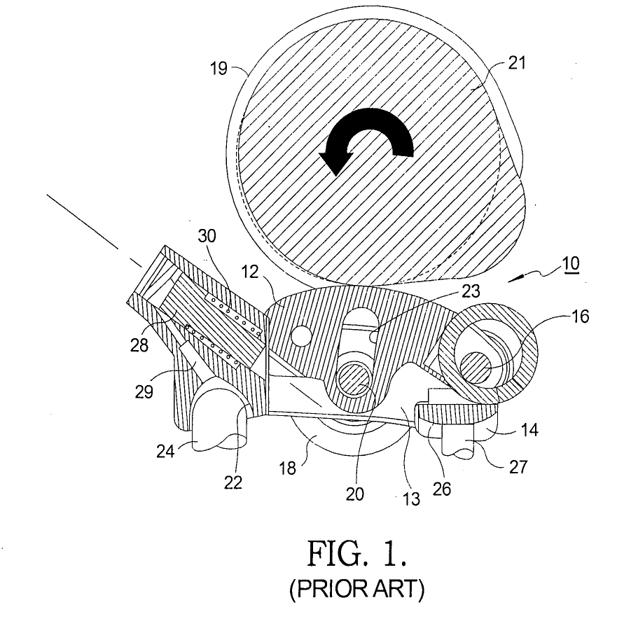

Referring to FIG. 1, a prior art two-step roller finger follower (RFF) 10 includes an inner arm 12 that is pivotably disposed in a central opening 13 in an outer arm 14. Inner arm 12 pivots within outer arm 14 about a pivot shaft 16. A roller 18 for following a cam lobe 19 of a lifting cam of an engine camshaft 21 is carried by a shaft 20 that is supported by outer arm 12. Slot 23 in inner arm 12 provides clearance to shaft 20 when inner arm 12 pivots about shaft 16. A socket 22 for pivotably mounting RFF 10 on a hydraulic lash adjuster (HLA) (not shown) is included at one end of outer arm 14. A ball end 24 of the HLA is received by socket 22. A pad 26 for actuating a valve stem 27 is included at an opposite end of outer arm 14. A lock pin 28 or other latching mechanism disposed within outer arm 14 at the same end as socket 22 selectively couples or decouples inner arm 12 to or from outer arm 14, which enables switching from a high lift mode to a low lift mode and vice versa. Controlled by an engine control module, pressurized oil supplied by the HLA through oil passage 29 in known fashion hydraulically biases lock pin 28 from a retracted position to an expanded position toward inner arm 12. When engine control module determines, in known fashion from various engine operating parameters, that inner arm should be unlocked to switch to low lift mode, the oil pressure is reduced such that a return spring 30 may bias lock pin 28 to a retracted position away from inner arm 12. All of these relationships are known in the two-step RFF prior art and need not to be further elaborated here.

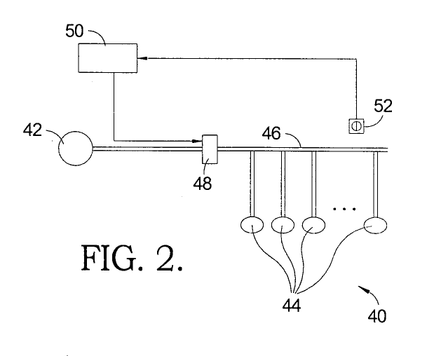

Referring to FIG. 2, an engine control system 40 includes an oil pump 42 that delivers oil to switchable mechanisms 44, such as a plurality of two-step roller finger followers 10 (FIG.) via an oil gallery 46. Oil gallery 46 may be a common HLA supply/switching gallery for all switchable mechanisms 44. Oil gallery 46 is a hydraulic gallery. An oil control valve 48 is positioned between oil pump 42 and oil gallery 46 and, therefore, upstream of oil gallery 46. An engine controller 50 activates and controls oil control valve 48. A pressure transducer 52 positioned between oil gallery 46 and engine controller 50 is utilized to monitor the oil pressure in oil gallery 46.

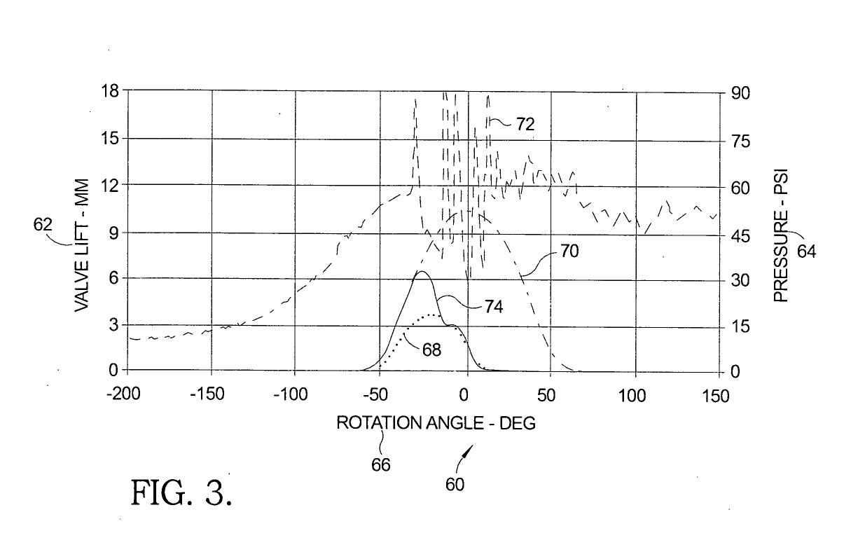

Pressure transducer 52 measures the fluid pressure in the oil gallery 46 and generates an output signal in form of an electrical signal related to the measured pressure. Engine controller 50 may be programmed to acquire the output signal, from pressure transducer 52 at certain times and for certain time periods. For example, engine controller 50 may be programmed to monitor oil pressure 64 (FIG. 3) of oil gallery 46 during a specified time interval following a switch command, such as a command to switch from low lift mode or no lift mode to high lift mode or vice versa, by acquiring the output signal of pressure transducer 52 at that time. Engine controller 50 may use measured data from pressure transducer 52 for diagnostic of the flow in oil gallery 46 and to detect failure modes of lock pin 28 (shown in FIG.1). As described above, failure modes of lock pins 28 may include, but are not limited to, lock pin ejections and operation of two-step RFF 10 in a low lift mode at elevated engine speeds where typically operation in high lift mode is needed.

While FIG. 2 shows pressure transducer 52 to detect a fluid pressure and to produce an electrical output signal related to the pressure, it might be possible to use other types of pressure sensors. While only one pressure transducer 52 is shown to monitor oil gallery 46, which is a common HLA supply/switching gallery for all switchable mechanisms 44, it may be possible to use additional transducers including the case of one pressure transducer 52 for each switchable mechanism 44. Besides detecting failure modes of lock pin 28, pressure transducer 52 may in addition be used for pulse width modulation oil pressure control instead of mechanical pressure control via control valve 48 as shown in FIG. 2.

Referring to FIGS. 3 through 5, diagnostic of a fluid pressure 64 in oil gallery 46 (shown in FIG. 2) is utilized to detect lock pin ejections, in accordance with a first embodiment of the invention.

Graph 60 illustrated in FIG. 3 shows an exemplary relationship between a valve lift 62 and oil pressure 64 of oil gallery 46, and a rotation angle 66 of cam lobe 19 (FIG. 1) corresponding to a lock pin ejection. Trace 68 represents the valve lift associated with two-step RFF 10 (shown in FIG.1) in low lift mode, trace 70 represents the valve lift associated with two-step RFF 10 in high lift mode, and trace 72 represents the pressure in oil gallery 46. The measured oil pressure 64 increases when control valve 48 (FIG. 2) is opened to increase oil pressure 64 to extend lock pin 28 toward a locked position for engagement with inner arm 12 and to switch to high lift mode. As can be seen in a trace 74, lock pin 28 starts to engage with inner arm 12 and RFF 10 starts to operate at high lift mode following trace 70, lock pin ejection occurs and RFF 10 is operated in low lift mode following trace 68. Accordingly, the valve lift initially follows the prescribed lift for high mode but then abruptly changes to the lift associated with the low lift event at about −30 degrees rotation angle 66. As a result, the oil pressure 64 starts oscillating at a high frequency. These high frequency pressure oscillations indicate sudden flow changes in oil gallery 46 and are characteristic of a lock pin ejection.

Failure modes, such as the lock pin ejection, may be detected by comparing the pressure characteristics of normal switches, for example from low lift mode to high lift mode as shown in trace 70, to the pressure characteristics actually observed after the switching event as shown in trace 74. Accordingly, an abnormal pressure characteristic permits the detection of a failure mode, such as a lock pin ejection, for example in the operation of RFF 10.

Trace 72 in graph 60 has been recorded using pressure transducer 52 integrated into engine control system 40 (FIG. 2) to detect oil pressure 64 in oil gallery 46 and to produce an electrical signal related to the pressure that may be acquired from engine controller 50. Engine controller 50 may be programmed to monitor oil pressure 64 in gallery 46 during a specified time interval following a switch command to switch, for example, from low lift mode to high lift mode or vice versa. Controller may only sample during the lift event of the first cylinder exposed to the pressure change associated with the switch command.

Various methods can be used to post-process the pressure data to determine with relatively high certainty if a failure mode of lock pin 28, such as lock pin ejections, has occurred. By post-processing the pressure data provided by pressure transducer 52, the presence of high frequency variations or fluctuations in the oil pressure 64 in the oil gallery 46 can be clearly identified.

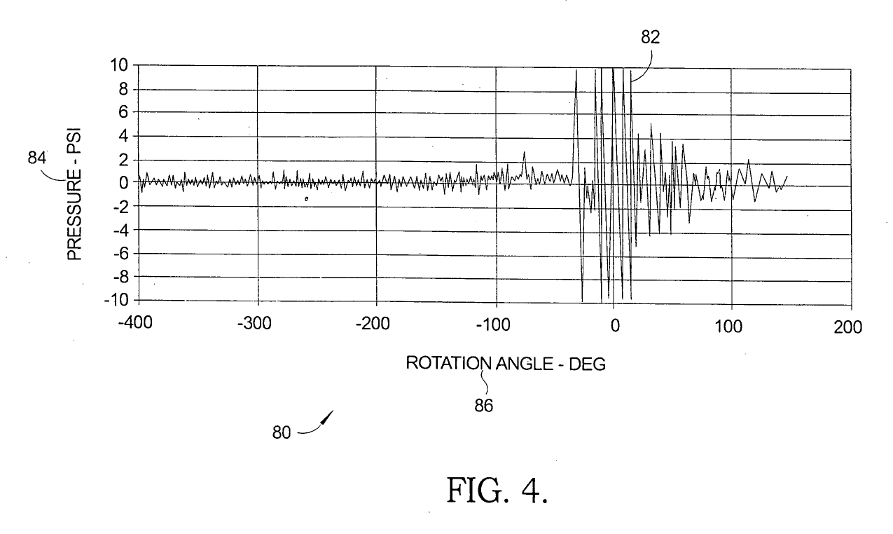

For example, in FIG. 4 a graph 80 shows a calculated relationship between fluid pressure 84 of oil gallery 46 and a rotation angle 86 of cam lobe 19 (FIG. 1) based on a relatively simple forward difference equation. The data points of a trace 82 have been calculated by engine controller 50 from the output data of pressure transducer 52 using a forward difference equation where the difference of consecutive oil pressure 64 data samples is calculated. As illustrated in FIG. 4, graph 80 clearly indicates a failure mode. The oscillations of the calculated values for oil pressure 84 have relatively small values until a rotation angle 86 of about −30 degrees. At this point high frequency oscillations having relatively large values occur, indicating sudden and unwanted flow changes in oil gallery 46 and, therefore, a failure mode. As shown in graph 80, the onset of the high frequency oscillations can be clearly identified and associated with a rotation angle 86 of cam lobe 19. Accordingly, the nature of the failure mode may be determined based on graph 80 and information from engine controller 50. For example, trace 82 could indicate a lock pin ejection during the switching from a low lift mode to a high lift mode.

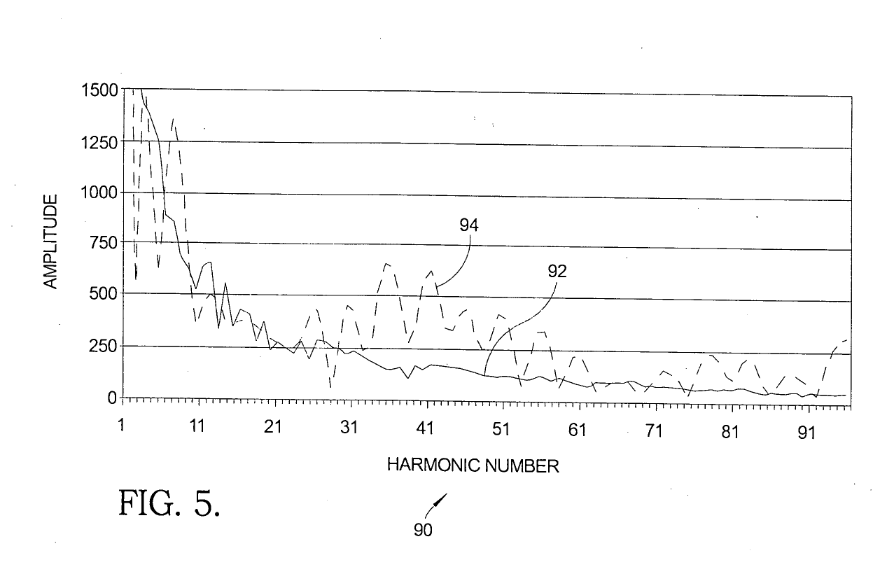

Referring now to FIG. 5, a fast Fourier transform (FFT) method was used to calculate traces 92 and 94 in graph 90. Trace 92 shows a baseline where no undesired sudden flow changes in the oil gallery 46 and, therefore, no failure mode of lock pin 28 occurred. Trace 94 indicates that high frequency variations in the oil pressure data 64 were present in the range of the harmonic number from about 26 to about 56. These high frequency variations in the oil pressure data indicate a failure mode of lock pin 28 or other latching mechanism.

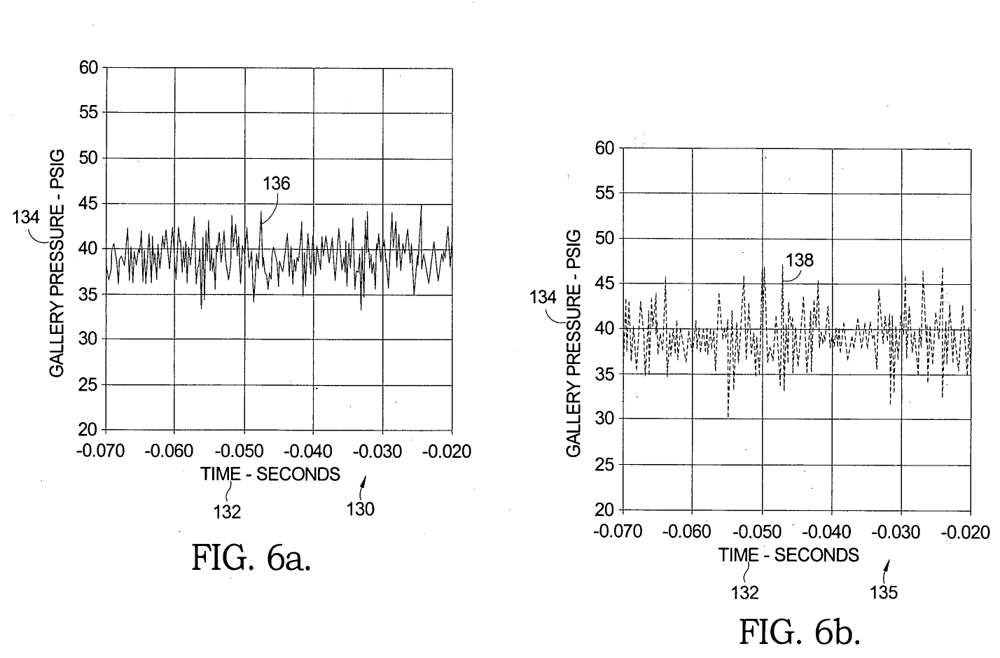

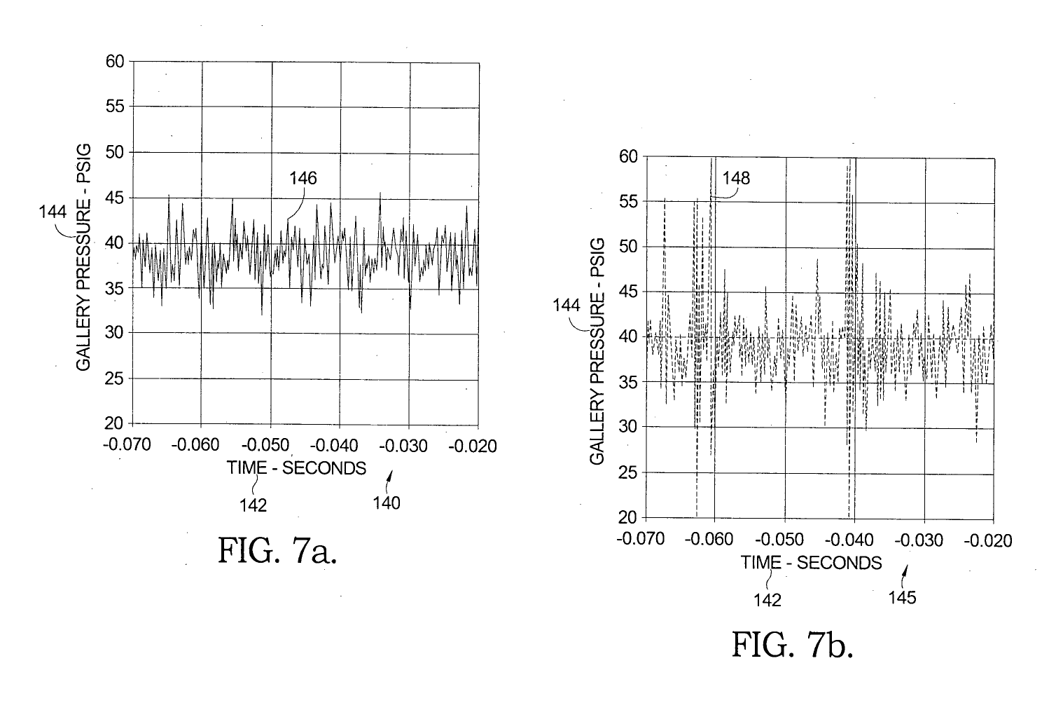

Referring to FIGS. 6 through 8, diagnostic of a fluid pressure 124 in oil gallery 46 (shown in FIG. 2) is utilized in accordance with a second embodiment of the invention to detect abnormal operation of a hydraulically switchable variable valve activation system of an internal combustion engine, such as two-step roller finger follower 10 (shown in FIG. 1) at high engine speeds. By comparing the pressure characteristics of normal high speed operation, where all switchable mechanisms 44 (shown in FIG. 2) are operated in high lift mode, to the pressure characteristics actually observed at high engine speeds, abnormal engine operation may be detected, where at least one of the switchable mechanisms 44 is stuck in low lift mode while all other switchable mechanisms 44 are operated in high lift mode. To detect abnormal operation of a hydraulically switchable variable valve activation system of an internal combustion engine at high speeds, the timing of when the controller acquires the pressure data from pressure transducer 52 (FIG. 2) is not important. For example the duration of the sample taken as illustrated in FIGS. 6a, 6b, 7a, and 7b is about three to four revolutions of cam lobe 19 (FIG. 1). This is contrary to the ejection diagnostic, as illustrated in FIGS. 3 to 5, where the controller only samples during the lift event of the first cylinder exposed to the pressure change associated with the switch command.

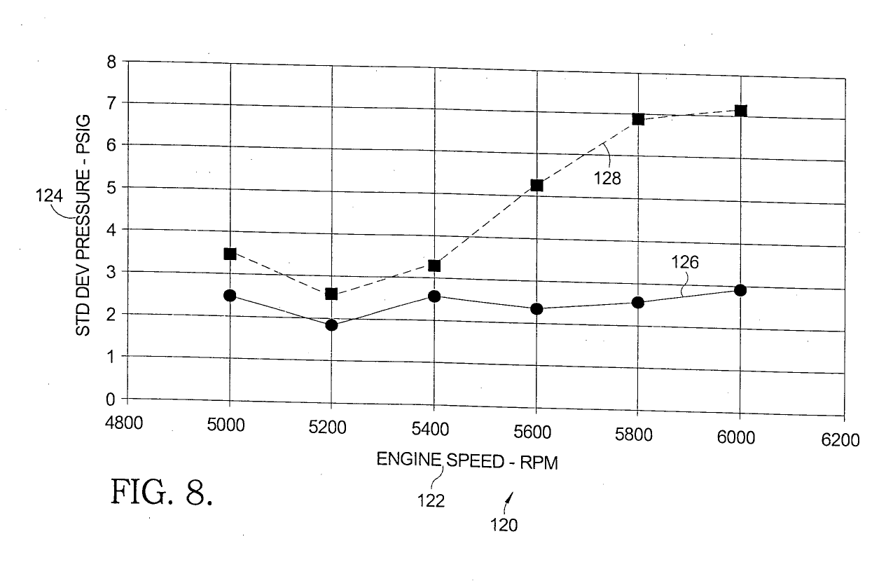

Referring to FIGS. 6a and 6b, graph 130 and graph 135 show oil gallery pressure 134 as a function of time 132 at an engine speed 122 (shown in FIG. 8) of about 5200 rpm. Graph 130 includes trace 136 (solid line) and graph 135 includes trace 138 (dashed line). Trace 136 illustrates oscillations of oil gallery pressure 134 for normal engine operation where all switchable mechanisms 44 (shown in FIG. 2), such as a plurality of two-step RFFs, are operated in high lift mode. Trace 136 illustrates oscillations of oil gallery pressure 134 when one of the switchable mechanisms 44 is stuck in low lift mode while all other switchable mechanisms 44 are operated in high lift mode. As can be seen, at the engine speed 122 of about 5200 rpm, at a speed where operation of switchable mechanism 44 in a low lift mode may not be detrimental, there is only a slight difference between trace 130 and trace 135 that may not be detectable.

Referring to FIGS. 7a and 7b, graph 140 and graph 145 show oil gallery pressure 144 as a function of time 142 at an engine speed 122 (shown in FIG. 8) of about 5500 rpm. Graph 140 includes trace 146 (solid line) and graph 145 includes trace 148 (dashed line). Trace 146 illustrates oscillations of oil gallery pressure 144 for normal engine operation where all switchable mechanisms 44 (shown in FIG. 2), such as a plurality of two-step RFFS, are operated in high lift mode. Trace 146 illustrates oscillations of oil gallery pressure 144 for abnormal engine operation where one of the switchable mechanisms 44 is stuck in low lift mode while all other switchable mechanisms 44 are operated in high lift mode. As can be seen, at the engine speed 122 of about 5500 rpm, there is a detectable difference between trace 146 and trace 148, which can be employed to diagnose the lock pin failure mode (failure mode of lock pin 28 shown in FIG. 1) where a hydraulically activated variable valve mechanism, such as two-step roller finger follower 10 (shown in FIG. 1), is operated in low lift mode at elevated engine speeds 122.

Graph 120 illustrated in FIG. 8 shows the standard deviation of fluid pressure 124 of oil gallery 46 (shown in FIG. 2) as a function of engine speed 122. Graph 120 includes trace 126 (solid line) and trace 128 (dashed line). Trace 126 shows the standard deviation of oil gallery pressure 124 as a function of engine speed 122 for normal engine operation where all switchable mechanisms 44 (shown in FIG. 2), such as a plurality of two-step RFFs, are operated in high lift mode. The data point for an engine speed 122 of about 5200 rpm in trace 126 may be calculated, for example, from data shown in FIGS. 6a and 7a. Trace 128 is the standard deviation of oil gallery pressure 124 as a function of engine speed 122 when one of the switchable mechanisms 44 is stuck in low lift mode while all other switchable mechanisms 44 are operated in high lift mode. The data point for an engine speed 122 of about 5500 rpm in trace 128 may be calculated, for example, from data shown in FIGS. 6b and 7b.

As shown in FIG. 8, there is a significant difference between the two traces 126 and 128 above an engine speed 122 of about 5400 rpm. This difference can be used to diagnose a lock pin failure mode of operation of a switchable mechanism 44 in low lift mode at elevated engine speeds 122. Detection of the lock pin failure mode is desirable, since running an engine with one of the switchable mechanisms 44 stuck in low lift mode may lead to hardware failure, since the system 40 is not designed to operate in low lift mode at elevated engine speeds 122. While graph 120 uses standard deviation as the measure, other measures based on oil gallery pressure 124, such as, for example, peak-to-peak, Fourier transform, or difference equation, may be used.

As illustrated in FIGS. 3 through 8, the oil pressure of the oil gallery 46 detected with pressure transducer 52 is suitable for diagnostic of the flow in oil gallery 46 and for 15 detection of lock pin 28 failure modes, including, but not limited to, lock pin ejections and operation of a switchable mechanism 44, such as two-step RFF 10 (FIG. 1) in low lift mode at elevated engine speeds. Failure modes of lock pin 28 generate a pressure disturbance in the oil flow in oil gallery 46 that can be recorded by pressure transducer 52 as shown in FIG. 3 and that can be evaluated by engine controller 50 as shown in FIGS. 3-9.

Once engine controller 50 (FIG. 2) detects a failure mode of lock pin 28 (FIG. 1), there are several possibilities for the application of the obtained knowledge. For example, engine controller 50 may provide feedback to adjust switch timing to reduce or avoid failure modes of lock pin 28. Furthermore, engine controller 50 may monitor the failure rate over a preset time period and if too many failure modes of lock pin 28 are detected, engine controller may set a malfunction code and alert the engine operator, for example, by turning on the engine alert light. Still further, it may be possible to monitor the number of failure modes of lock pin 28 for each engine cylinder individually with engine controller 50 and to adjust switch timing such that failure modes of lock pin 28 are distributed equally across all cylinders.

In the second embodiment, the controller can adjust engine parameters to limit engine speed, thereby protecting against hardware failure. A malfunction code may be set for the detection of one or more of the hydraulically switchable variable valve activation systems operating in the wrong mode at a high engine speed and the engine speed may be limited to a safe level if the malfunction code is activated.

While the invention has been described in connection with a two-step RFF 10, it may be applicable for other hydraulically switchable engine mechanisms.

While pressure transducer 52, which detects a fluid pressure and produces an electrical output signal related to the pressure, has been described above, it may be possible to use other types of pressure sensors. While only one pressure transducer 52 is shown in FIG. 2 to monitor oil gallery 46, which is a common HLA supply/switching gallery for all switchable mechanisms 44, it may be possible to use multiple transducers up to and including the case of one pressure transducer 52 for each switchable mechanism 44.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for detecting failure modes of latching mechanisms in a hydraulically switchable variable valve activation system of an internal combustion engine, comprising the steps of:
integrating a pressure sensor in an engine control system including at least one switchable mechanism connected to a hydraulic gallery, an oil control valve in fluid communication with said hydraulic gallery, and an engine controller activating said oil control valve and acquiring an output signal from said pressure sensor;
measuring a fluid pressure of said hydraulic gallery with said pressure sensor; and
determining if a failure mode of said at least one switchable mechanism occurred by evaluating characteristics of said measured fluid pressure.

2. The method of claim 1, further including the steps of:
sending data related to said measured fluid pressure from said pressure sensor to an engine controller for diagnostic; and
post-processing said data with said engine controller.

3. The method of claim 1, further including the steps of:
utilizing a pressure transducer as said pressure sensor;
detecting said fluid pressure with said pressure transducer;
producing an electrical signal related to said fluid pressure; and
acquiring said electrical signal with said engine controller for diagnostic.

4. The method of claim 1, wherein said at least one switchable mechanism is a plurality of switchable mechanisms.

5. The method of claim 4, further including the steps of:
integrating a pressure sensor into said hydraulic gallery for each of said switchable mechanisms in an engine control system; and
monitoring said fluid pressure of said hydraulic gallery near each of said switchable mechanisms individually.

6. The method of claim 1, further including the step of:
programming said engine controller to monitor said fluid pressure of said hydraulic gallery during a specified time interval following a switch command via said pressure sensor.

7. The method of claim 1, further including the step of:
using a forward difference equation based on said fluid pressure at consecutive data samples for post-processing said data.

8. The method of claim 1, further including the step of:
using a fast Fourier transform method to identify the presence of high frequency variations in said fluid pressure data obtained by said pressure sensor.

9. The method of claim 1, further including the step of:
utilizing said pressure sensor for pulse width modulation oil pressure control via a control valve of said engine control system.

10. The method of claim 1, further including the step of:
identifying the presence of abnormal high frequency variations in said fluid pressure data provided by said pressure sensor relative to known pressure characteristics of normal switches.

11. The method of claim 1, further including the steps of:
adjusting a switch timing command based on determination of said failure mode of latching mechanisms; and
minimizing the occurrence of said failure mode.

12. A method for detecting lock pin failure modes in a hydraulically switchable two-step roller finger follower of an internal combustion engine, comprising the steps of:
integrating a pressure transducer in an engine control system between a common oil gallery and an engine controller;
monitoring an oil pressure of said oil gallery with said engine controller via said pressure transducer; and
identifying the presence of abnormal high frequency variations in said oil pressure.

13. The method of claim 12, further including the steps of:
obtaining pressure data of said oil gallery with said pressure transducer;
producing an electrical output signal related to said pressure data with said pressure transducer;
acquiring said electrical output signal from said pressure transducer with said engine controller; and
post-processing said data with said engine controller.

14. The method of claim 12, further including the step of:
programming said engine controller to monitor said oil pressure of said oil gallery during a specified time interval following a switch command.

15. The method of claim 12, further including the step of:
identifying a lock pin ejection.

16. The method of claim 12, further including the step of:
identifying operation of said two-step roller finger follower in a low lift mode at elevated engine speeds.

17. The method of claim 12, further including the steps of:
comparing characteristics of said monitored oil pressure to characteristics of oil pressure for normal operation of said hydraulically switchable two-step roller finger follower; and
identifying abnormal high frequency oscillations of said oil pressure in said oil gallery.

18. The method of claim 12, further including the step of:
integrating a plurality of said pressure sensor in said engine control system.

19. The method of claim 12, further including the steps of:
monitoring frequency of lock pin failure mode occurrences;
detecting a rate of said lock pin failure modes above a threshold value; and
setting a malfunction code.

20. The method of claim 12, wherein a plurality of hydraulically switchable two-step roller finger followers are included and further including the steps of:
monitoring the number of said lock pin failure modes for each of said two-step roller finger followers connected with said common oil gallery; and
adjusting switch timing to distribute lock pin failure modes evenly across all of said two-step roller finger followers.

21. The method of claim 12, further including the steps of:
setting a malfunction code for detection of one or more of said hydraulically switchable two-step roller finger followers operating in the wrong mode at a high engine speed; and
limiting engine speed to a safe level if said malfunction code is activated.

22. An engine control system of an internal combustion engine, comprising:
a plurality of hydraulically switchable mechanisms including a hydraulically activated latching mechanism receiving oil from an oil pump via a common oil gallery;
an oil control valve in fluid communication with said oil gallery;
a pressure sensor positioned to detect an oil pressure of said oil gallery; and
an engine controller activating and deactivating said oil control valve and said pressure sensor;
wherein said pressure sensor sends obtained data of said oil pressure to said engine controller for diagnostic; and
wherein said engine controller detects the presence of abnormal high frequency variations in said data of said oil pressure and identifies a failure mode of said latching mechanisms.

23. The engine control system of claim 22, wherein said pressure sensor is a pressure transducer.

24. The engine control system of claim 22, wherein said hydraulically switchable mechanisms are two-step roller finger followers.

25. The engine control system of claim 22, wherein said failure mode of said latching mechanisms includes lock pin ejections and operation of said hydraulically switchable mechanisms in a low lift mode at elevated engine speeds.
